(19) United States
(12) Patent Application Publication
(10) Pub. No.: US 2016/0318785 A1
(43) Pub. Date: Nov. 3, 2016

(54) COMPACT SCALABLE MODULAR SYSTEM AND METHOD FOR TREATMENT OF WATER

(71) Applicant: BENCHMARK ENVIRONMENTAL, INC., Seattle, WA (US)

(72) Inventor: Mark Anthony ENSLOW, Seattle, WA (US)

(21) Appl. No.: 15/141,654

(22) Filed: Apr. 28, 2016

Related U.S. Application Data
(60) Provisional application No. 62/153,941, filed on Apr. 28, 2015.

(51) Int. Cl. C02F 9/00; C02F 11/12; C02F 1/463; C02F 1/00

(52) U.S. Cl. CPC C02F 9/00; C02F 1/008; C02F 11/12; C02F 1/463; C02F 2001/007; C02F 1/001; C02F 1/325

(57) ABSTRACT

A compact scalable modular system and process for treatment of water. Various water treatment components may be integrated into a scalable module to reduce an overall footprint of the module and accommodate easier installation without significant time and cost. The integrated treatment components in the module may be customized based on the target pollutants to treat, such as soluble and insoluble organic and inorganic substances, or expected quality of effluent water, such as for human consumption, and industrial or environmental usage, to achieve. A two-phase separation system may be used in a combination with any treatment component. One such embodiment includes a treatment component in a combination with a coagulation and flocculation treatment component so that the pollutants may be coagulated and flocculated before the separation process of the coagulants and flocculants. By using settling plates or tubes, the two-phase separation system embodiment may effectively form floatable solids and settlable solids. The floatable solids may be removed from the separation component by a sludge skimmer or a device with a similar function and the floatable solids may be removed from the separation component by a sludge rake or pump.

### CLAIM TO PRIORITY APPLICATION

This application claims the benefit of U.S. Provisional Application No. 62/153,941, entitled “Scalable, uni-body, system of the treatment of water,” filed Apr. 28, 2015, which is incorporated by reference in its entirety herein for all purposes.

### BACKGROUND

Water costs have been getting higher every year over the last couple of decades. With increasing rates of urbanization and the global water crisis, it has become imperative to treat, recycle, and reuse the existing water resources. Contaminated water is often complicated to treat as such water often contains a variety of pollutants and substances, such as chemicals, metals, oil, biological contaminants. Treating polluted water efficiently and economically is a challenge.

For example, in a conventional water treatment solution, a series of water treatment steps are required to target each separate contaminant, which typically involves discrete and structurally independent treatment stages or components using chemical, biological, electrical, and physical methods. Such discrete and structurally independent treatment components tend to require a lame designated space in a facility. A series of treatment components are connected to each other and typically operate in concert once the operation starts. On the other hand, for a smaller scale water treatment, arranging each the treatment components into a small space is a challenge as the components, especially components for primary treatment and settlable solids removal.

Each conventional treatment component contains a discrete system for treatment. The conventional system then includes several discrete components connected to each other as a series and, therefore, frequent regular maintenance of each system is necessary to avoid malfunction. One common process of the water treatment is to convert soluble substances to solids, settle the solids, and dewater them for removal out of the water treatment system. However, common settling systems with electrocoagulation as primary treatment require a long time for floatable solids to settle in degassing stages before solids are removed, and therefore the size of the settling systems tend to be very large and expensive.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a block diagram of a scalable automated modular system for treatment of water according to an embodiment of the subject matter disclosed herein;

FIG. 2 is a view of a further embodiment of the scalable modular system with a water treatment capacity of 2,000 gallons per day according to an embodiment of the subject matter disclosed herein;

FIG. 3 is an internal view of the embodiment of FIG. 2 according to an embodiment of the subject matter disclosed herein;

FIG. 4 is a view of a further embodiment of the scalable modular system with a water treatment capacity of 216,000 gallons per day according to an embodiment of the subject matter disclosed herein;

FIG. 5 is an internal view of the embodiment of FIG. 4 according to an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. The expansile roll-up cuffs may, however, be embodied in many different forms and should not be construed as limited to the embodiments set forth herein; rather, these embodiments are provided so that this disclosure will satisfy the statutory requirements and convey the scope of the subject matter to those skilled in the art.

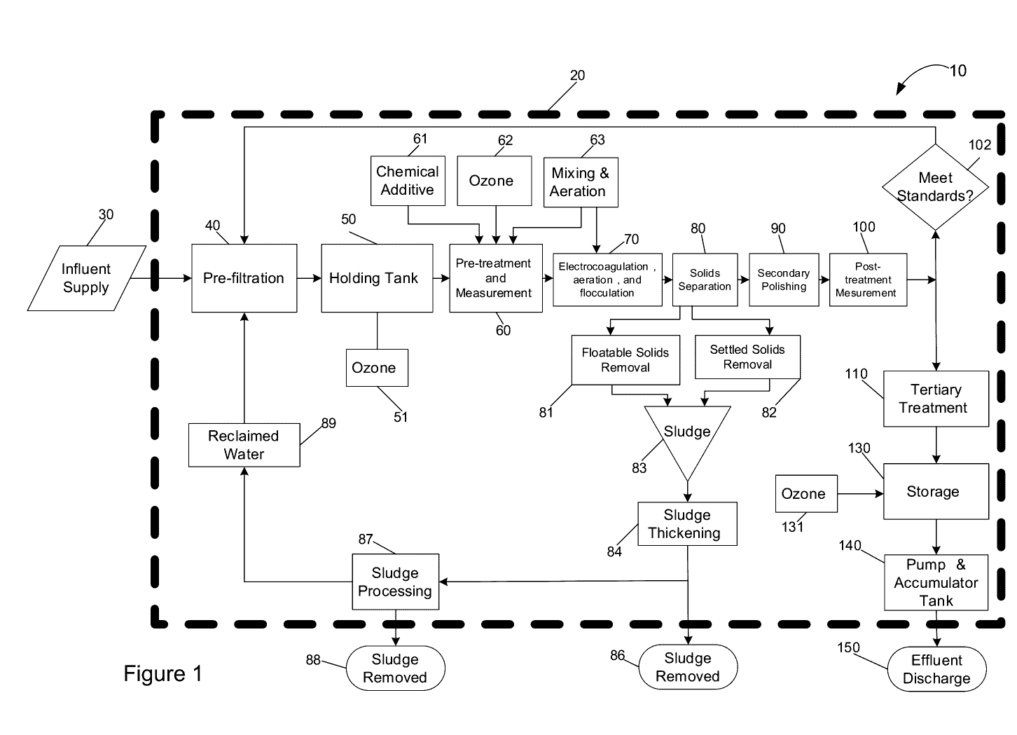

By way of overview, the subject matter disclosed herein may be directed to a compact scalable modular system and process for treatment of water. Various water treatment components with scalable primary electrocoagulation treatment component and solids settling and settable component may be integrated and enclosed into a scalable module to reduce an overall footprint of the module and accommodate easier installation without significant time and cost. The integrated treatment components in the module may be customized based on the target pollutants to treat, such as soluble and insoluble organic and inorganic substances, or expected quality of effluent water, such as for human consumption, and industrial or environmental usage, to achieve. A two-phase separation system, which may segregate floatable solids from settlable solids and remove both from the system, may be used in a combination with any treatment component. One such embodiment includes a treatment component in a combination with a coagulation and flocculation treatment component so that the pollutants may be coagulated and flocculated before the separation process of the coagulants and flocculants. By using settling plates or tubes, the two-phase separation system embodiment may more effectively form and remove floatable solids and settable solids. The floatable solids may be removed from the separation component by a sludge skimmer or a device with a similar function and the floatable solids may be removed from the separation component by a sludge rake or pump. These and other advantages will become more apparent in the detailed descriptions below with respect to FIGS. 1-5.

FIG. 1 is a block diagram of a scalable automated modular system 10 for treatment of water. The scalable modular system 10 comprises a scalable module for water treatment 20 and, in one embodiment, the module 20 further comprises pre-treatment components 40, 50, 60, primary treatment component 70, separation component 80, polishing component 90, post-treatment components 100, 110, 130, 140. Influent supply of water 30 may be provided to the module 20 for treatment through an inlet attached to the module 20. The influent water 30 is typically contaminated or polluted, which may be coupled to existing or new infrastructure via open-channel flow or closed-channel flow (above or below ground). In one embodiment, the open-channel flow allows easier installation of the module 20. The treatment within the module 20 is performed by the treatment components 40, 50, 60, 70, 80, 90, 100, 110, 130, 140 and effluent discharge 150. After treatment, through the module 20, clean water is discharged from the module 20 via the effluent discharge 150. The discharge may be done by gravity or via a pump and conveyed to a sewer, holding tank, or duct or pipe returning back to the pre-treatment components 100, 110, 130, 140. In a further embodiment, the influent water 30 may include chemicals, metals, oil, biological contaminants and any combination thereof. Such contaminants and pollutants are then removed by the module 20 through various components as described next.

The pre-treatment components 40, 50, 60 may be disposed between the influent water 30 and the primary treatment component 70 and connected with each other by a tube, pipe, duct, channel, hose, and any combination thereof. The influent water 30 can be conveyed between the components using gravity or a pump. One of the pre-treatment components, pre-filtration component 40, may remove all the large insoluble and free-floating particles from the influent water 30. In one embodiment, the pre-filtration component 40 may use a filter (not shown), including a mechanical mesh filter, mechanical bar filter, hydrodynamic vortex separator, sump, and other similar filters. The pre-filtration component 40 may be directly connected to the influent water 30 of the module 20. In one embodiment, the pre-filtration component 40 may include a self-cleaning apparatus for cleaning the filter. Such a self-cleaning apparatus may be a filter with automatic flush valve to flush out trapped sediment through centrifugal action, vertical or horizontal self-cleaning filter with a motor-driven mechanical piston mechanical particle remover with automatic flush valve, and other similar self-cleaning apparatuses.

Another one of the pre-treatment components, a holding tank or surge tank 50, may be a storage tank in this embodiment and absorb an excess flow of the influent water 30 to accommodate varying flow rates of the influent water 30. In one embodiment, the surge tank 50 may provide ozone pre-oxidization treatment to remove organic and inorganic matter and micro-pollutants. The surge tank 50 may take the form of a bio swale, retention basin, plastic tank, metal tank, composite tank, and other similar tanks. In this embodiment, the surge tank 50 is coupled to the pre-filtration component 40 and pre-treatment and measurement component 60. The surge tank can be positioned inside or outside the module 20.

The pre-treatment and measurement component 60 may measure and monitor conductivity and pH of the influent water 30. Such measuring and monitoring may be performed by one or more sensors (not shown), which may sense influent flow rates, conductivity, pH, turbidity, and other information of the influent water 30 and convey sensor information to a controller (not shown) connected to the sensor.

The controller may include a Programmable Logic Controller (PLC) or embedded controls (not shown) to receive a signal from the sensor and measure each value of a target for sensing. The controller can also upload and download information from the internet or from local devices, for the purpose of sending and receiving information to change control methodology, data log performance, send error messages and maintenance reminders, and other functions. For example, if pH and conductivity of the influent water 30 are out of a targeted range, the influent water 30 may be adjusted. To adjust a certain value of the influent water 30, such as conductivity, pH, turbidity, based on the information obtained from the measurement, the pre-treatment and measurement component 60 may add water chemical additives 61 to control pH and conductivity of the influent water 30. In one embodiment, the pH and conductivity may be adjusted by adding chemicals, such as sodium hydroxide to increase pH and alkalinity, sulfuric acid to decrease pH, and sodium chloride saturated solution to increase conductivity through a metered dosing pump, which may be stored in a container inside or outside of the system 20. In a further embodiment, the effluent water 150 may be saturated by solid state sodium chloride by sending an effluent recycle stream from 150 through a fluidized bed or pack bed of the sodium chloride (not shown) to reduce frequent replacement or maintenance of the sodium chloride solution. In a still further embodiment, to lower the pH, adding a bed of sulfuric acid provided by a metered dosing pump may be added. In a still further embodiment, to increase the pH, a bed of calcite, sodium hydroxide provided by a metered dosing pump, and any combination thereof may be added.

Further, the pre-treatment and measurement component 60 as the pre-treatment component may water chemical additives 61 to promote coagulation and flocculation. The chemical additives 61 may be supplied as a solution, tablets, powder, or any combination thereof. Coagulants are positively charged molecules and neutralize the negative electrical charge on a particle. Flocculants gather the destabilized particles together and agglomerate the particles into solids. The coagulants and flocculants may include aluminum chloride, aluminum sulfate, polyacluminum chloride, aluminum chlorohydrate, ferric chloride, polyamine, polydiallyldimethylammonium chloride (polyDADMAC), melamine formaldehydes, tannins, cationic flocculants, such as copolymers of N,N-Dimethylaminoethyl acrylate methyl chloride quaternary and acrylamide or copolymers of N,N-Dimethylaminoethyl methacrylate methyl chloride quaternary and acrylamide, and anionic flocculants, based on copolymers of acrylamide and acrylic acid.

Further, ozone treatment 62 may be used to remove further substances from the influent water 30. Ozone may be created and provided to the treatment with ozone gas bubbles. By providing ozone, biological contaminants (not shown) in the influent water 30, pathogenic or non-pathogenic protozoan, viruses, and bacteria become disinfected. In one embodiment, the ozone treatment 51, 62 may target cyst-forming protozoa, methicillin-resistant staphylococcus aureus (MRSA), clostridium difficile, and clostridium difficile spores, and any combination thereof to disinfect. In a further embodiment, the ozone treatment 51, 62 may target iron, manganese, and sulfur to remove unfavorable tastes and odors from the influent water 30.

The chemical additives 61 and ozone treatment 62 may be added to the pre-treatment and measurement component 60 by the mixing and aeration 63 of the component 60 in order to ensure proper treatment of the influent water 30. The mixing and aeration 63 can be performed by, but not limited to, an inline mixer, mechanical mixer, aerator, static mixer, large bubble vertical mixer, flow dividers, injection nozzles, and any combination of thereof. In one embodiment, the pre-treatment and measurement component 60 can be a separate component.

The primary treatment component 70 may be coupled to any of the pre-treatment components 40, 50, 60. In this embodiment, the primary treatment component 70 is coupled to the pre-treatment and measurement component 60 so that the pH and conductivity are suitably adjusted for electrocoagulation, electrofloatation, and/or chemical coagulation. The primary treatment component 70 typically comprises metal electrodes (not shown) to destabilize and coagulate suspended particles and solute pollutants in the influent water 30. The metal electrodes may be made of iron, aluminum, titanium, graphite, or other similar materials, and each material may have electrochemical coagulant characteristics to remove certain target contaminants. In one embodiment, the electrodes may be metal plates. It is appreciated that the electrodes are in a parallel position to promote coagulation and flocculation, but other orientations are possible. In one embodiment, each electrode may be connected in parallel-monopolar configuration, but may be in any other suitable configuration for coagulation and flocculation.

The mechanism of electrocoagulation and electroflocculation is based on the metal electrodes, such as aluminum (Al³⁺) or iron (Fe²⁺), having an electrical charge and reacting with water (H₂O) to produce metal ions and electrons. The metal ions and electrons destabilize the surface charges on suspended pollutants and allow the metal ions to bind do the pollutant particles.

The coagulated and flocculated solids (not shown) may be formed into large stable flocculent molecules, which may be removed from the influent water 30. The coagulated and flocculated solids include organic and inorganic materials, metallic materials, bacteria, and emulsified oils, and any combination thereof. For inherent problems of using electrocoagulation and electroflocculation treatment, such as electrode passivation, electron/ion concentration gradients, and laminar flows may be prevented by adding the mixing and aeration 63 to the primary treatment component 70, periodically reversing electrode polarity, and adding sodium chloride. The mixing and aeration 63 can be performed by, but not limited to, an inline mixer, mechanical mixer, aerator, static mixer, large bubble vertical mixer, flow dividers, injection nozzles, and any combination of thereof. The coagulated and flocculated solids (not shown) may be transferred to separation component 80 for removal.

The coagulated and flocculated solids travel into separation component 80 where the solids are removed from the water passage. By using a series of plates or tubes (not shown) that are inclined in parallel, the coagulated and flocculated solids may be settled at faster rates. The larger the surface area of the plates and tubes, the faster and more effective the rate of flotation and sedimentation of the coagulated and flocculated solids. The settling plates may be constructed as stainless steel, plastic, or similar materials. The solids may be separated as floatable solids 81 and settable solids 82. The floatable solids 81 may be formed by gas bubbles, typically hydrogen, generated as a process of electrocoagulation lift individual flocculant molecules. A sludge layer is formed at the surface of the solids separation component 80.

Separating the floatable solids 81 is unique from existing water treatments because the floatable solids 81 are removed before they have time to settle. Existing systems have an extra process called degassing, which is highly time dependent process, as it takes time and possibly mechanical agitation to disassociate the gas from the floc structure of the coagulated and flocculated solids. Degassing components are large and heavy as they need to store large volumes of water over a long period. Removing the floatable solids before it has time to settle eliminates the need for a degassing component, which reduces the size, weight, and cost of the module 20. Methods for removing floatable solids may include rotating dynamic or static sludge skimmer, chain and flight sludge scraper, floatable solids skimmer, and any combination thereof.

A flow-diverting baffle (not shown) for guiding the floatable and settlable solids to laden water down through a series of settling plates may be used. This baffle may only allow a flow to go down through a first set of plates, and then diverts the flow up through a second set of plates. This flow pattern effectively forms a floatable solids trap by removing the floatable solids in the first set of plates, and prevents floatable solids from continuing.

The settlable solids 82 may be formed by the flow-diverting baffle directing the water and settlable solids up through the second set of settling plates and allowing enough time and area for settlable solids to accumulate at the bottom of the separation component 80 for removal. Sedimentation may be removed via a screw conveyor, sludge rake or boom, pump, or a tool with similar function. The parallel and inclined plates and tubes may have a feature of self-cleaning, such as a large bubble vertical mixer and similar devices.

The collected floatable solids 81 and settable solids 82 may be combined as sludge 83. The sludge 83 may be thickened 84 for further process and removal. The sludge 83 may be further processed 87 for dewatering by using filter bags, filter press, centrifuge, continuous belt filter press, or similar devices. The dewatered sludge 88 can be removed in batches or in a continuous process. Through this process, the water 89 can be removed by dewatering and may be returned back into the beginning of the system 20 for further process through a valve (not shown). The sludge 83 may also leave the system untreated 86.

The clarified water after going through the pre-treatment components 40, 50, 60, primary treatment components 70, and separation component 80 may be further treated by a polishing component 90 with many different treatments, such as filtration, activated charcoal media, chemical absorptive media, glass or sand filter media, and any combination thereof. In this embodiment, the polishing component 90 may be incorporated after the pre-treatment components 40, 50, 60, primary treatment components 70, and separation component 80. If the polishing component 90 is a discrete component, such as a filter cartridge or pressure vessel, the influent water 30 may be pumped into the vessel.

After the influent water 30 is treated by the polishing component 90, a quality of the water, such as pH, turbidity, and total dissolved solids (TDS), may be measured by a sensor or similar measuring devices. If the measured water quality does not meet a standard (depicted as decision component 102), a valve (not shown) may direct the influent water 30 to the beginning of the system 20. If the standard is met, the water may be further processed through a tertiary treatment component 110, which may involve UV disinfection component using ultraviolet germicidal irradiation (UVGI) and reverse osmosis. Water may be stored at a storage 130 and ozone treatment 131 may be applied at the storage 130 to avoid proliferation of biological contaminants. The treated water may be discharged as effluent water 150 from the system 20 and may be discharged by using a pump, downstream pressure pump, and gravity for the open-channel flow. In one embodiment, an accumulator tank 140 may be installed to reduce pump cycling and absorb demand spikes.

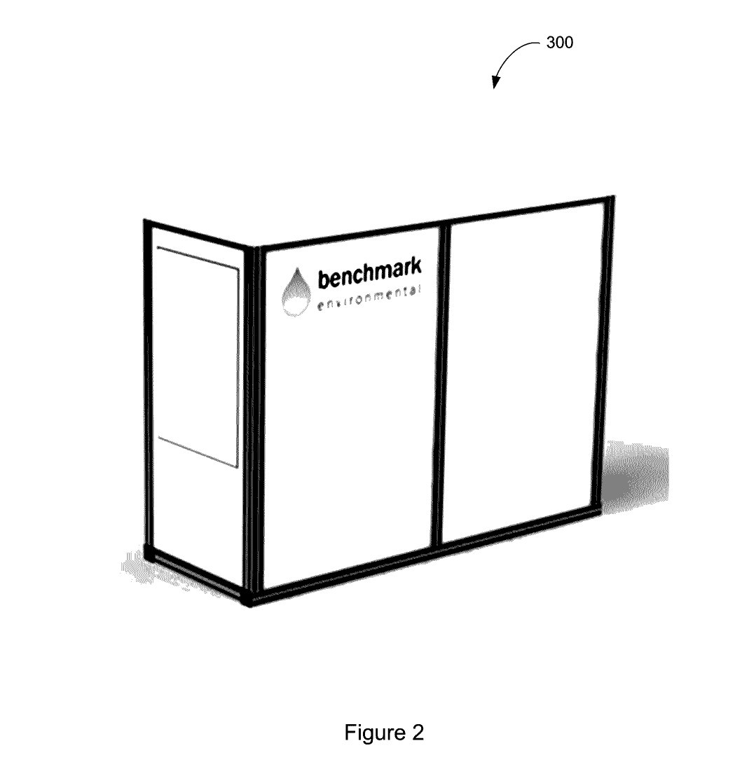

The module 20 as described with respect to FIG. 1 may be scalable in that several modules 20 may be part of a larger system 10 that provides for multiple parallel treatment paths for influent water 30. Once such system may be the embodiment shown in FIG. 2.

FIG. 2 is a view of a further embodiment of the scalable modular system 300 with a water treatment capacity of 2,000 gallons per day.

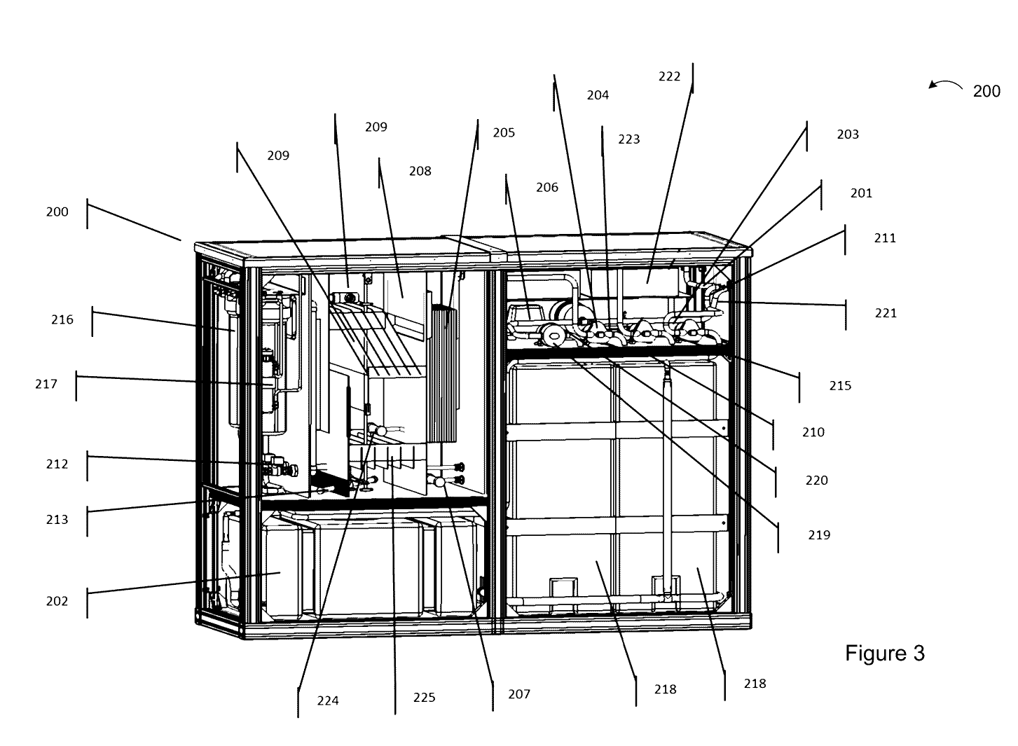

FIG. 3 is an internal view of the embodiment of FIG. 2. This embodiment of the scalable modular system 200 has a treatment capacity of 2,000 gallons per day. The influent water enters a surge tank 201 through a pre-filter and automatic valve (not shown), and is stored in a holding tank 202 to accommodate fluctuations in the flow. An ozone generator 203 disinfects and pre-treats the influent water inside the holding tank 202. A primary treatment pump 204 conveys the influent water into a primary treatment component 205. Electrocoagulation electrodes 206 destabilize and coagulate pollutants (not shown). A direct current power supply (not shown) provides electrical current to the electrocoagulation electrodes 206. An electric aerator (not shown) mixes and aerates the primary treatment component 205 with an aeration head 207. Then, the water with coagulated and flocculated pollutants is conveyed by gravity into solids separation component 208. Floatable solids in the water are collected via static skimmer 209, and removed via a sludge pump 210 out of the system 200, as a slurry 211. Automatic valves 212 divert the sludge pump suction 210 to a rotating settlable solids removal boom 213 and remove a sludge via sludge pump 210 out of the system 211, as a slurry. Inclined and parallel flotation and sedimentation plates (not shown) assist with this task. Anti-short circulation baffles 225 ensure laminar flow throughout solids separating component 208. Clarified water is removed from solids separation component 208 via a secondary primary treatment pump 215 and enters a secondary polishing component 216 and a UV disinfection component 217. The clarified water is stored in tanks 218 and periodically disinfected with an ozone generator 203. When the clarified water is needed, a demand/supply pump 219 and accumulator tank 220 pump the clarified water out of the system 200 through outlet 221 and maintain water pressure in the line (not shown). The system 200 is monitored and controlled by an embedded controller 222. Over the time, flocs settle on the flotation/settling plates 214. Periodically, as a self-cleaning measure, a valve 223 diverts flow from the electric aerator 206 to destabilize settled solids via an aeration head 224, and allows it to resettle in the solids separation component 208 to be removed by the sludge pump 210 and rotating settlable solids removal boom 213.

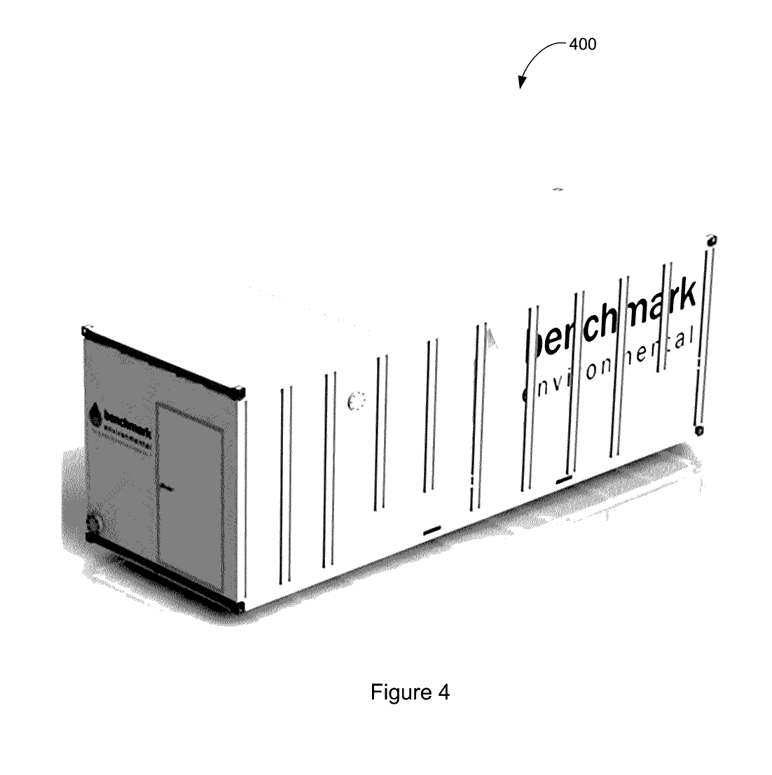

FIG. 4 is a view of an embodiment of the scalable modular system 400 with a water treatment capacity of 216,000 gallons per day.

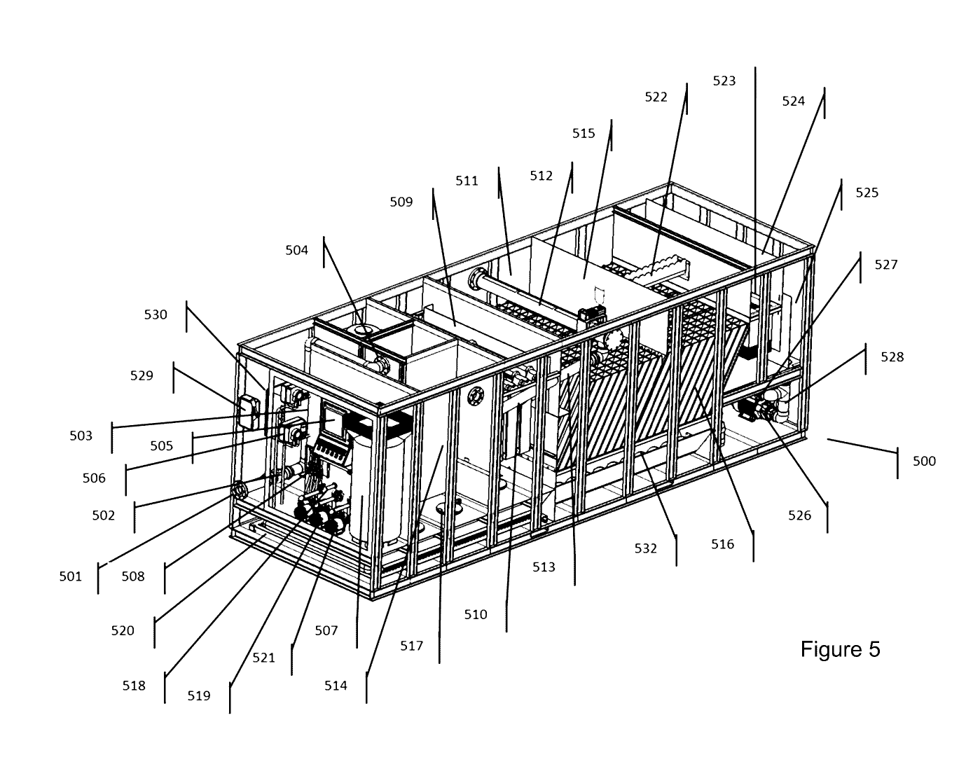

FIG. 5 is an internal view of the embodiment of FIG. 4. Water enters the system 500, runs through a check valve 502, flow meter (not shown), and flows into a pretreatment and measurement component 504. Sensors (not shown) detect pH, turbidity levels, and TDS. An embedded controller 505 operates appropriate chemical dosing pumps 506, if necessary. Compressed air from an air compressor 507 is released in timed bursts via automatic valves 508 through dissipation manifolds 517 to create an energy efficient and thorough mixing of the pretreatment and measurement component 504 and primary treatment component 509. The water is conveyed via open-channel flow into the primary treatment component 509. Electrocoagulation plates 510 destabilize and coagulate pollutants (not shown). The water with coagulated and flocculated pollutants is conveyed by gravity into a solids separation component 511. Floatable solids (not shown) are collected via a rotating sludge skimmer 512, and removed via a gravity feed 513 into a sludge settling area 514. Flow of the water is diverted via a flow diversion baffle 515. The water and flocculants flow down through flotation/settling plates 516, then flow up through the floatation/settling plates 516, respectively. Settlable solids accumulate at the bottom of the solids separation component 511. Screw conveyors 532 convey settled solids into a sludge trough (not shown) and are pumped 518 into the sludge settling area 514. Once the sludge settling area 514 is full, the sludge slurry in the sludge settling area 514 is pumped 519 through dewatering filter bags 520. Reclaimed water (not shown) is collected and pumped 521 back into the beginning of the system 500. Clarified water is created by the solids separation component 511 via a v-notched weir 522 and is conveyed by gravity into a secondary polishing component 523. The clarified water flows down through chemical absorptive and mechanical filtration media (not shown). In the event the secondary polishing component 523 becomes fouled (plugged), the water is backed up and passed over an overflow bypass weir 524 in to a post treatment and measurement component 525. If water quality standards are not met, a pump 526 via automatic valves 527 and pipes 528 recirculate the water into the beginning of the system 500. If water quality standards are met, the pump 526 via automatic valves 527 and pipes 528 discharge the water through outlet (not shown). In one embodiment, water can be discharged via open-channel flow through the outlet. If the water is to be removed from the solids separation component 511 for any reason, a bypass valve (not shown) can be opened and the pump 526 via automatic valves 527 and pipes 528 discharges the water through the outlet from the solids separation component 511. Power is introduced to the system 500 via a high voltage junction box 529. A power supply 530 provides direct current power to the electrocoagulation plates 510, as required by the embedded controller 505. Over the time, flocs settle on the flotation/settling plates 516. Periodically, as a self-cleaning measure, timed bursts of compressed air is diverted via the valve 508 through dissipation manifolds 517 below the floatation/settling plates 516 to destabilize settled material, and material to resettle on conveyor screws 532 for removal.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

What is claimed is:

1. A scalable modular water-treatment system, comprising:
a module having a space for water treatment components;
an inlet configured to receive influent water;
a plurality of water treatment components disposed in the space and coupled to each other to treat the influent water; and
an outlet configured to produce treated water from the plurality of water treatment components;
wherein the plurality of treatment components includes:
a primary treatment component for destabilizing and coagulating solids from the influent water;
a two-phase separation component for separating solids into floatable solids and settlable solids and removing the floatable solids and settlable solids from the influent water; and
a polishing component for further removing dissolved pollutants from the influent water.

2. The system of claim 1, further comprising:
a measurement component configured to determine one or more characteristics of the influent water; and
a controller configured to adjust the treatment of the influent water in response to the determining of the one or more characteristics.

3. The system of claim 2, further comprising:
a sensor configured to measure a value for each of the one or more characteristics of the influent water;
the controller configured to analyze whether the value is below a standard; and
a return flow valve configured to return the influent water from the measurement component into the primary treatment component for the processing.

4. The system of claim 1, further comprising at least one of:
a pre-treatment component disposed between the inlet and the primary treatment component and configured to process the influent water for promoting the processing of the primary treatment; and
a post-treatment component disposed between the polishing component and the outlet and configured to process the influent water further before discharging from the outlet.

5. The system of claim 4, wherein at least one of the pre-treatment component and post-treatment component comprises at least one of filters, oxidizing feature, conductivity adjustment feature, chemical coagulation/flocculation feature, pH adjustment feature, and UV for the further processing.

6. The system of claim 1, further comprising:
a storage component configured to accommodate an excess amount of the influent water into the module through the inlet.

7. The system of claim 1, wherein the primary treatment component comprises an electrocoagulation and electroflocculation feature for forming coagulants and flocculants.

8. The system of claim 7, further comprising:
a plurality of plates and inclined and disposed in parallel; and
a mixing feature in the primary treatment component configured to prevent sticking of the coagulants and flocculants on the plurality of plates.

9. The system of claim 1, further comprising:
a sludge component configured to receive the removed floatable and settlable solids;
a thickening component configured to further separate water from the received solids; and
a sludge valve configured to return the separated water as reclaimed water into the plurality of water treatment components.

10. A process for treatment of water, comprising:
receiving influent water into a module having a space for water treatment components coupled to each other to treat the influent water through an inlet;
producing treated water from the plurality of water treatment components, wherein the treated water production further comprising:
destabilizing and coagulating solids from the influent water in a primary treatment component;
separating the solids as floatable solids and settlable solids and removing the floatable solids and settlable solids from the influent water via a two-phase separation component; and
further removing dissolved pollutants from the influent water via a polishing component.

11. The process of claim 10, further comprising:
determining one or more characteristics of the influent water via a monitoring component;
adjusting the treatment of the influent water in response to the determining of the one or more characteristics by a controller.

12. The process of claim 11, further comprising:
measuring the value for each of the one or more characteristics of the influent water by a sensor;
analyzing whether the value is below a standard by the controller; and
returning the influent water from the measurement component into the primary treatment component for the processing by a return flow valve.

13. The process of claim 10, further comprising at least one of:
processing the influent water for promoting the processing of the primary treatment by a pre-treatment component disposed between the inlet and the primary treatment component; and
processing the influent water further before discharging from the outlet by a post-treatment component disposed between the polishing component and the outlet.

14. The process of claim 13, wherein at least one of the pre-treatment component and post-treatment component comprises at least one of filters, oxidizing feature, conductivity adjustment feature, chemical coagulation/flocculation feature, pH adjustment feature, and UV for e further processing.

15. The process of claim 10, further comprising:
accommodating an excess amount of the influent water in a storage of the module through the inlet.

16. The process of claim 10, wherein the primary treatment component comprises an electrocoagulation and electroflocculation feature for forming coagulants and flocculants.

17. The process of claim 16, further comprising:
a plurality of plates and inclined and disposed in parallel; and
a mixing feature in the primary treatment component for preventing sticking of the coagulants and flocculants on the plurality of plates.

18. A scalable modular water-treatment system, comprising:
a plurality of modules, each module having a space for water treatment components;
an inlet configured to receive influent water;
a plurality of sets of water treatment components respectively disposed in each space of each of the plurality of modules, each of the plurality of modules coupled to each other to treat the influent water, each set of water treatment components further comprising:
a primary treatment component configured to destabilize and coagulate solids from the influent water;
a two-phase separation component configured to separate solids into floatable solids and settlable solids and to remove the floatable solids and settlable solids from the influent water; and
a polishing component configured to further remove dissolved pollutants from the influent water; and
an outlet configured to produce treated water from the plurality of water treatment components.

19. The system of claim 18, further comprising:
a measurement component configured to determine one or more characteristics of the influent water and measure a value for each of the one or more characteristics by a sensor;
analyze whether the value is below a standard; and
a return flow valve configured to return the influent water from the measurement component into the primary treatment component for the processing.

20. The system of claim 18, further comprising at least one of:
a pre-treatment component disposed between the inlet and the primary treatment component and configured to process the influent water for promoting the processing of the primary treatment; and
a post-treatment component disposed between the polishing component and the outlet and configured to process the influent water further before discharging from the outlet.
